(19) United States
(12) Patent Application Publication
(10) Pub. No.: US 2023/0230383 A1
(43) Pub. Date: Jul. 20, 2023

(54) Method for checking a static monitoring system

(71) Applicant: Continental Automotive Technologies GmbH, Hannover (DE)

(72) Inventors: Michael Goldhammer, Haibach (DE); Peter Quittenbaum, Bad Vilbel (DE); Alexander Sauermann, Alzenau (DE)

(73) Assignee: Continental Automotive Technologies GmbH, Hannover (DE)

(21) Appl. No.: 18/150,219

(22) Filed: Jan. 5, 2023

(30) Foreign Application Priority Data
Jan. 5, 2022 (DE) 10 2022 200 075.7

(51) Int. Cl. G06V 20/54; G06V 10/26; G06V 10/34; G06V 10/75

(52) U.S. Cl. CPC G06V 20/54; G06V 10/26; G06V 10/34; G06V 10/75

(57) ABSTRACT

A system and method of inspecting a static monitoring installation, installed in a traffic space. An evaluation circuit is able to create an image of the environment from a signal reflected from an object, wherein at least one reference value of a reference image of the environment is stored in the evaluation circuit, and the at least one reference value is formed from the reflected signals of at least one reference point for a reflected signal

### CROSS-REFERENCE TO RELATED APPLICATIONS

The present application claims priority from German Patent Application No. 10 2022 200 075.7 filed on Jan. 5, 2022, in the German Patent and Trade Mark Office, the content of which is herein incorporated by reference in its entirety.

### BACKGROUND

### 1. Field

Aspects of the present application relate to a method for inspecting a static monitoring installation comprising a signal transmitter for transmitting a signal and a signal receiver that is able to receive the signal from the signal transmitter reflected from an object, and comprising an evaluation circuit that is able to create an image of the environment from the received signal.

### 2. Description of Related Art

Static monitoring installations are used to monitor areas of traffic or the traffic in the areas of traffic. The results of the monitoring may be used for example to control flows of traffic or individual vehicles.

Systems consisting of a signal transmitter and a signal receiver are used for the monitoring, for example. The signal transmitted by the signal transmitter is reflected from objects and may be received by the signal receiver. The type and the direction of the reflection and the signal strength of the reflected signal may be used to determine the position of objects and thus to create an image of the environment.

Moving objects are recognized for example by detecting changes in the images of the environment that are created from the reflected signals or changes in the signal (time of flight, frequency. etc.).

The area to be monitored may however be fully or partially blocked by stationary objects. Since these objects do not move, it is often difficult to recognize them using the methods provided for recognizing moving objects.

In addition, substances in the air or clouding on or in front of the sensors may lead to restrictions or blockages of the monitoring installation.

### SUMMARY

According to an aspect of an embodiment, there is provided a method for inspecting a static monitoring installation, which method exhibits improved recognition of static obstacles in the monitoring field of the monitoring installation.

To achieve the aspect, provision is made for a method for inspecting a static monitoring installation, comprising a signal transmitter for transmitting a signal and a signal receiver that is able to receive the signal from the signal transmitter reflected from an object, and comprising an evaluation circuit that is able to create an image of the environment from the received signal, wherein at least one reference value of a reference image of the environment is stored in the evaluation circuit, wherein the at least one reference value is formed from the reflected signals of at least one reference point for a reflected signal. The method comprises the following steps:
creating a comparison image from the reflected signals,
forming a comparison value of the comparison image from the reflected signals of the comparison image,
comparing the comparison value of the comparison image and the reference value of the reference image and determining the value of a deviation of the comparison value and the reference value,
comparing the value of the deviation with a threshold value for the deviation and outputting a blockage signal when the value of the deviation exceeds the threshold value.

Each reflection in the reference image generates a reference point. The evaluation circuit is able to create an image of the monitoring space from the position of the reference points and additional information, such as direction, signal time of flight or signal strength. Moving objects may be recognized for example by way of moving reference points or the characteristic of the reflected signal.

At least one reference value is formed from the reflections of the reference image and stored. This reference value thus characterizes the traffic space without static obstacles that restrict the detection range of the monitoring installation.

During operation of the monitoring installation, a comparison image that represents the current status of the traffic space is created from the reflections. Moving objects may be detected for example by way of changes of reflections or the type of reflections. Furthermore, a comparison value is formed from the reflections of the comparison image, wherein the comparison value is ascertained using the same method as the reference value.

If, during operation of the monitoring installation, a static obstacle is present in the detection range of the monitoring installation, this completely or partially conceals individual static objects at all times. The signals therefore cannot reach the static object and/or the signal receiver. Signals may also be reflected from the obstacle, wherein the reflections from the obstacle have a characteristic different from the reflections from the concealed static objects.

If a comparison value is created from the reflections of the comparison image, this deviates from the reference value, since not all reflections that were taken into consideration for the reference value are present, or additional reflections are present. If there is such a deviation between the comparison value and the reference value, and no moving objects that cause these reflections or that conceal objects are detected, it is possible to assume a static obstacle that completely or partially conceals the monitoring area.

To reduce the influence of brief obstacles or moving objects, at least one threshold value is defined. A stationary visual obstruction and/or a blockage in the detection range of the monitoring installation is assumed only when the deviation of the comparison value from a reference value exceeds this threshold value.

If such a visual obstruction or a blockage is detected, a signal is then output in order to be able to react thereto, for example by inspecting the monitoring installation and rectifying any visual obstructions that may be present.

To reduce the influence of briefly occurring visual obstructions, for example a stopped vehicle, the comparison image and/or the comparison value is smoothed, in particular temporally smoothed. A respective value is thus ascertained over a relatively long period of time for the at least comparison value. An obstacle that is briefly present thus has only a small influence on the comparison value. The threshold value is in this case preferably selected such that the influence of a visual obstruction up to a defined time leads to a comparison value the deviation of which from the reference value is below the threshold value.

The reference value may also be smoothed for example using a low-pass filter.

By way of example, multiple comparison images may also be recorded with a time offset and at least one comparison value may be formed for each comparison image. The comparison values may each be compared with the reference value and a value of the deviation of the comparison value and the reference value may be determined. The comparison values and/or the values of the deviations may additionally be compared with one another. For example, if the values of the deviation increase, this may indicate that a blockage is increasing or is taking over a larger part of the monitoring area. On the other hand, a decreasing value of the deviation may indicate that the blockage is clearing and is not a permanent blockage.

The change in the comparison values and/or changes in the value of the deviation may additionally be used to influence the trigger time of the blockage signal. By way of example, in the case of a decreasing value of the deviation, it may be assumed that the blockage is clearing or is not permanently present. In this case, the blockage signal may for example be blocked or time-delayed in order to wait for further comparison values.

Comparing the comparison values and/or the values of the deviations with one another additionally also makes it possible for example to detect visual blockages that build up slowly, for example clouding on a window or a lens due to soiling in the case of optical systems or soiling on a cover in the case of acoustic or electromagnetic systems.

The one or more threshold values are for example defined beforehand and/or prescribed by fixed values. By way of example, the threshold values that are defined beforehand are average values that have been ascertained in trials or with other monitoring installations and that make it possible to distinguish between moving obstacles and static obstacles.

As an alternative or in addition, the threshold values may also be adapted during operation of the monitoring installation, in particular on the basis of the values of the deviation and/or the changes in the comparison values. This may be used to improve monitoring accuracy in order to be able to reliably identify blockages. By way of example, the threshold value may be increased if it turns out that there are often brief blockages that could lead to triggering of the blockage signal. If the values of the deviations are always considerably below the threshold value, the threshold value may be reduced in order to recognize blockages more quickly.

The reference image is for example fixedly prescribed and is recorded beforehand.

The reference image may optionally also be adapted, in particular on the basis of the captured comparison images. This makes it possible for example to take into consideration changes in the static elements in the monitoring area, as a result of which monitoring accuracy is able to be improved. By way of example, a new reference image may be captured at regular intervals, for example when it is detected that there are no moving objects and no blockages in the monitoring space.

The reference image may be divided into different areas, with at least one reference value being formed for each area, and with the blockage signal containing information about the areas in which the value of the deviation of a comparison point from the reference point exceeds the threshold value. In the event of a partial blockage of the monitoring area of the monitoring installation, it is thus possible to detect where the visual obstruction is located.

By way of example, different threshold values may also be specified for different areas. By way of example, in some areas that are particularly important to monitor, it is possible to set lower threshold values such that a blockage signal is output even in the event of comparatively short-term visual blockages.

The reference value and the comparison value may be formed from the reflections of the signals in different ways. By way of example, the reference value and the comparison value may be formed from the number of received signals received by the signal receiver.

By way of example, the signal strength and the signal characteristic of the individual reflections is also taken into consideration when forming the reference value and the comparison value. By way of example, a radar cross section (RCS) or an effective backscatter area, from which the reference value or the comparison value is formed, is acquired for individual reflections.

A common reference value or a common comparison value may optionally also be formed from the radar cross sections of the reflections, for example a total value or an average value of the radar cross sections.

### BRIEF DESCRIPTION OF THE DRAWINGS

Further advantages and features will become apparent from the following description in connection with the appended drawings, in which:

FIG. 1 shows a schematic illustration of a monitoring installation;

FIG. 2 shows a schematic illustration of a recorded image of the monitoring installation from FIG. 1;

FIG. 3 shows a schematic illustration of a reference image of the monitoring installation from FIG. 1;

FIG. 4 shows a schematic illustration of a comparison image of the monitoring installation from FIG. 1 with an obstacle;

FIG. 5 shows a schematic illustration of a comparison image of the monitoring installation from FIG. 1 with clouding; and

FIG. 6 shows a second schematic illustration of a reference image.

### DETAILED DESCRIPTION

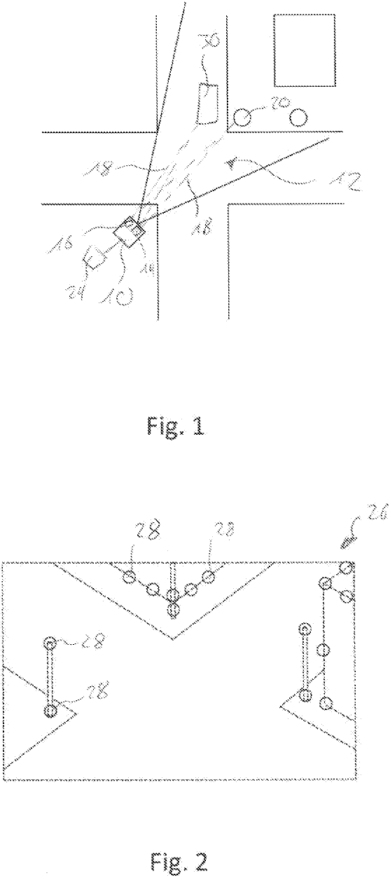

FIG. 1 shows a static monitoring installation 10 for a traffic space 12, in this example an intersection.

FIG. 1 shows only one monitoring installation 10. The traffic space 12 may however also contain multiple monitoring installations 10, for example in order to be able to monitor the traffic space 12 from different directions and/or perspectives. The monitoring installations 10 may be connected to one another or be connected to a common controller in order for example to compare the data from the monitoring installations 10 and/or to create a three-dimensional image of the traffic space 12.

The monitoring installation has a signal transmitter 14 and a signal receiver 16. The signal transmitter 14 transmits a signal 18, which is reflected from an object 20. The signal 18 is for example an optical, acoustic and/or electromagnetic signal. By way of example, the signal is a radar (radio detection and ranging) or lidar (light detection and ranging) signal.

If the signal 18 impacts an object 20, the signal 18 is reflected. The reflected signal 18 is detected by the signal receiver 16. The distance of the object 20 is able to be determined from the time of flight of the signal 18 from the signal transmitter 14 to the signal receiver 16. The direction of the object 20 is additionally able to be determined from the direction in which the signal 18 is transmitted and the direction from which the signal 18 is received by the signal receiver 16.

An image 26 of the traffic space 12 is able to be created in an evaluation circuit 24 from the received signals 22 or the direction and the distance of the objects 20. Each reflection may in this case be represented in this image 26 in simplified form by a point 28 (see FIG. 2).

The image 26 is constantly updated in order to recognize changes in the traffic space 12, for example moving objects 30 such as vehicles. By way of example, the signal transmitter 14 is pivoted or moved such that it captures the entire area to be monitored regularly or at a predefined frequency.

If a moving object 30 is located in the traffic space 12, this may be recognized through the fact that the reflections, that is to say the points 28 of this object in the image 26 change, for example change their position, or the time of flight and/or the frequency of the signal 22 increases or decreases.

Static objects, for example houses or traffic signs, on the other hand, provide a reflection of the signal 22 that is always the same, meaning that the points 28 that represent these static objects in the image 26 always remain unchanged.

During operation of such a static monitoring installation 10, there may be complete or partial blockages of the area to be monitored, for example caused by stationary objects 31 (see FIG. 4) that conceal areas of the traffic space 12 to be monitored. There may also be soiling or clouding directly in front of the signal transmitter 14 and/or the signal receiver 16 or in the signal path that completely or partially blocks the signal. By way of example, smoke, dense fog or precipitation may lead to partial or complete absorption of the signal 18.

Such blockages, soiling or clouding may limit the function of the monitoring installation 10, since the traffic space is no longer able to be monitored. It is therefore necessary to reliably and quickly recognize such problems in order to be able to rectify them. It is also necessary to reliably distinguish such problems from transient blockages, for example caused by a moving object.

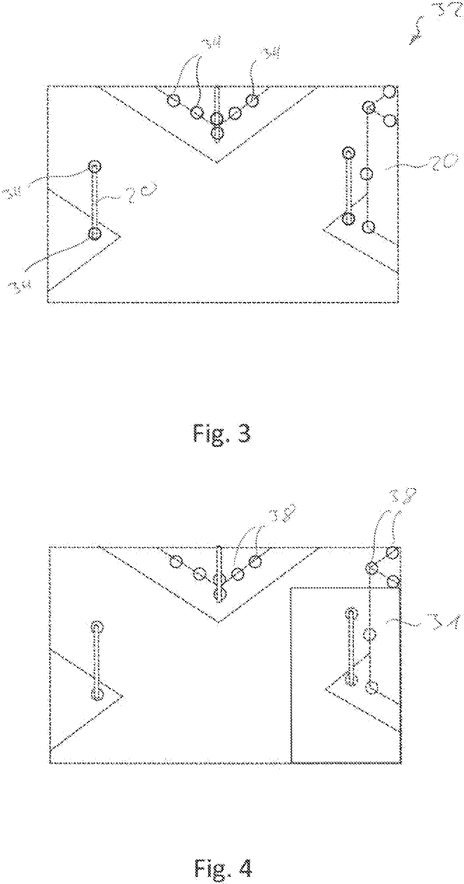

In order to reliably recognize such problems, a reference image 32 (FIG. 3) is created beforehand and stored in the evaluation circuit 24, said reference image representing the traffic space 12 without moving objects 30 and without visual obstructions.

The reference image 32 may for example be recorded beforehand or when the monitoring installation 10 is installed and stored in the evaluation circuit 24. By way of example, when or immediately after the monitoring installation 10 is installed, a state is produced and/or detected in which only static objects are located in the traffic space 12 to be monitored.

The reference image 32 thus contains only reflections 34 that characterize fixed objects. At least one reference value is acquired and/or formed from these reflections 34.

By way of example, a radar cross section (RCS) or an effective backscatter area is acquired for individual reflections 34.

A common reference value may optionally also be formed from the radar cross sections of the reflections 34, for example a total value or an average value of the radar cross sections. By way of example, the total number of reflections 34 and/or the number of reflections within a defined time may also be acquired.

The reference values thus formed are stored in the evaluation circuit 24. A threshold value is also stored for each reference value, with a comparison value not being allowed to deviate from this reference value by more than said threshold value.

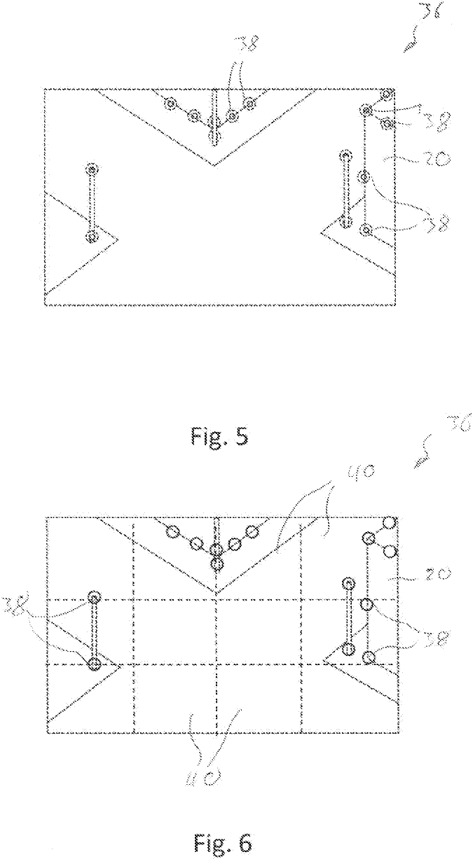

During operation of the monitoring installation 10, a comparison image 36 (FIGS. 4 and 5) is created from the received signals 22. The comparison image 36 may in this case represent a single recording of an image 26. The comparison image 36 may also be created from multiple images 26 recorded in temporal succession, for example in which the comparison image 36 is smoothed and/or filtered over a relatively long period of time.

At least one comparison value corresponding to the at least one reference value is acquired and/or formed for this comparison image 36. The comparison value is in this case formed from the reflections 38 of the current image of the monitoring installation 10, that is to say the comparison image 36.

The comparison values are compared with the corresponding reference values and a value of any deviation that is present between the reference value and the comparison value is determined. This value of the deviation is compared with the threshold value that is stored for the respective reference value. If the value of the deviation exceeds the threshold value, a blockage signal is triggered. The blockage signal may for example be received by a superordinate controller. The monitoring installation 10 may then for example be diagnosed or the monitoring installation 10 is controlled manually in order to verify and possibly remove the visual obstruction.

In addition to the reflections 34 from the static objects, reflections from objects that are present briefly, for example vehicles 30, also influence the comparison value. Static objects may also be at least partially concealed by moving objects for a short period of time.

To reduce these brief influences, the comparison image 36 is smoothed or filtered. By way of example, multiple comparison images 36 may be recorded with a time offset, in particular in immediate succession, and an average value may be formed from these images.

If some static objects are fully or partially concealed, this has a permanent influence on the at least one comparison value that is also not, or is only slightly, reduced by smoothing, filtering and/or averaging. On the other hand, the influence of a moving object on the comparison value decreases.

The threshold values of the reference values are in this case selected such that the changes in the comparison values caused by a transient visual obstruction are so low that the threshold values are not exceeded and the blockage signal is not triggered.

If the blockage persists over a longer period of time, the comparison values on the other hand change such that the threshold values are exceeded and a blockage signal is output.

The threshold values may be fixedly prescribed, for example when the monitoring installation 10 is installed. It is also possible for multiple threshold values to be prescribed.

In the case of multiple reference values, a blockage signal may also be output only when threshold values of different reference values are exceeded or a total threshold value formed from the individual threshold values is exceeded.

The threshold values may furthermore also be adjusted during operation of the monitoring installation 10. The threshold values may be adjusted for example on the basis of the comparison images or the comparison values.

By way of example, a threshold value may be reduced if it turns out, during operation of the monitoring installation 10, that the comparison value does not exceed a particular deviation from the reference value, or does so only extremely rarely.

If there are often brief blockages that lead to triggering of the blockage signal, the threshold value may also be increased in order to prevent incorrect triggering of the blockage signal.

Optionally or in addition, the reference image may also be adjusted and/or corrected during operation of the monitoring installation 10, as a result of which the reference values are also adjusted and/or corrected. This makes it possible for example to react to changes to static objects that do not limit the monitoring area of the monitoring installation 10.

The reference image and the comparison image may optionally be divided into areas 40 (FIG. 6), with at least one reference value being ascertained for each area and a comparison value corresponding to the reference value being determined. At least one threshold value is defined for each reference value.

For each of the areas, the at least one reference value is compared with the corresponding comparison value. If a threshold value defined for this area is exceeded, the blockage signal is output.

The areas make it possible to determine the blockage more accurately. If the threshold values are exceeded only in some areas of the comparison image, this may be an indicator of a partial blockage. If all threshold values are exceeded, the monitoring area of the monitoring installation is completely blocked. The position of the area in which the threshold value is exceeded may additionally be used to conclude as to where the blockage is located and how quickly it needs to be rectified.

By way of example, different threshold values or threshold values of different values may be defined for different areas. If frequent short blockages, for example caused by vehicles, are to be expected in an area, the threshold value may be set higher in order to prevent incorrect triggering of the blockage signal.

For areas of the reference image or of the comparison image in which brief blockages, for example caused by vehicles, are highly unlikely, the threshold value may accordingly be set lower.

The threshold values may furthermore be adjusted during operation of the monitoring installation 10, for example if it turns out that an area of the reference image or of the comparison image is frequently briefly blocked or areas of the reference image or of the comparison image are blocked very rarely.

The reference image 32 may furthermore be adjusted over the service life of the monitoring installation 10, for example by virtue of the evaluation circuit containing an algorithm that makes it possible to recognize new static objects and/or the change of static objects in the traffic space.

This makes it possible for example to recognize a moving visual obstruction that blocks individual reference points with greater reliability. By way of example, comparing the individual comparison images 36 makes it possible to check whether individual reference points 34 are blocked in all comparison images 36 or whether individual reference points 34 are visible again after a certain time, meaning that the remaining concealed reference points may be expected to be visible again. The evaluation circuit 24 may in particular hold back the blockage signal if such a situation is recognized.

Comparing the comparison images 36 with one another also makes it possible to recognize further static objects for which reference points 34 may be stored.

In addition to a complete blockage of one or all reference points 34, there may also be diffuse visual impairments, for example caused by strong clouding of the air or directly in front of the signal transmitter and/or the signal receiver. By way of example, substances in the air, such as rain, fog or smoke, may lead to strong absorption of the signals 18. Soiling on or in front of the signal transmitter and/or the signal receiver may also lead to absorption of the signals 18. In other words, the signal is still able to be transmitted and received, but reflection is considerably weaker due to the partial signal absorption (FIG. 5).

Such a visual impairment may also be detected using the method described above. By way of example, the absorption of the signals leads to the deviation in reference values and comparison values formed from the radar cross section or the effective backscatter area.

Different reference values and comparison values are preferably formed. If different signal values and/or signal characteristics are used, then errors may be minimized and/or more accurate information about the visual blockages may be obtained.

By way of example, a diffuse visual impairment caused by smoke or fog may lead to a large deviation of a comparison value formed from the radar cross section or the effective backscatter area from the corresponding reference value, while the deviation of a comparison value based on the number of reflections per unit of time from the corresponding reference value turns out to be lower, since reflections are present in spite of the diffuse visual impairment.

1. A method of inspecting a static monitoring installation, the method comprising:
creating a comparison image from the signals reflected from an object:
forming a comparison value of the comparison image from the reflected signals:
determining a deviation value between the comparison value of the comparison image and a reference value of a reference image formed from signals reflected from a reference point: and
outputting a blockage signal when the deviation value exceeds a threshold value.

2. The method according to claim 1, wherein the comparison image is temporally smoothed.

3. The method according to claim 2, further comprising smoothing the comparison image using a low-pass filter.

4. The method according to claim 3, wherein the comparison image comprises multiple comparison images recorded with a time offset, and
wherein comparison values are formed for each comparison image among the multiple comparison images.

5. The method according to claim 4, further comprising delaying the blockage signal based on a change in the comparison values or a change in the deviation value.

6. (canceled)

7. The method according to claim 5, further comprising adjusting the threshold values based on the deviation value.

8. (canceled)

9. The method according to claim 7, further comprising adjusting the reference image or the reference value based on the comparison image or the comparison value.

10. The method according to claim 9, wherein the reference image is divided into different areas, with at least one reference value being formed for each area, and
wherein the blockage signal comprises information about the areas in which the deviation value of a comparison point from the reference point exceeds the threshold value.

11. (canceled)

12. The method according to claim 1, wherein forming the reference value is based on signal strength or a signal characteristic of the signals reflected from the object.

13. (canceled)
